(19) United States
(12) Patent Application Publication
(10) Pub. No.: US 2025/0262811 A1
(43) Pub. Date: Aug. 21, 2025

(54) BLOWING MOLD FOR MOLDING A CONTAINER

(71) Applicant: S.I.P.A. SOCIETA' INDUSTRIALIZZAZIONE PROGETTAZIONE E AUTOMAZIONE S.P.A, Vittorio Veneto (IT)

(72) Inventors: Martino CABONI, Vittorio Veneto (IT); Silvio DA LOZZO, Vittorio Veneto (IT); Matteo ZOPPAS, ConeglIano (IT)

(21) Appl. No.: 18/856,262

(22) PCT Filed: Apr. 3, 2023
(86) PCT No.: PCT/IB2023/053341

§ 371 Date: Oct. 11, 2024

(30) Foreign Application Priority Data
Apr. 12, 2022 (IT) 102022000007196

(51) Int. Cl. B29C 49/48; B29C 49/00; B29C 49/56; B29L 31/00; B65D 1/02

(52) U.S. Cl. CPC B29C 49/4802; B29C 49/071; B29C 49/56; B65D 1/023; B29C 2049/4894; B29C 2949/0744; B29L 2031/7158

(57) ABSTRACT

A blowing mold (1) for molding a container (90), in particular a plastic bottle, by blow molding a preform (9) having a neck (93) and a neck ring (92), the blowing mold (1) being adapted to be opened and closed, and comprising at least two parts (25, 26) which, when the blowing mold (1) is closed, form a support (2), or striker plate, adapted to abut against the neck ring (92) of the preform (9); wherein a surface (20) of said support (2) is provided with one or more protrusions (21) adapted to come into contact with the portion (931) of the preform (9) below the neck ring (92), in particular to prevent a rotation thereof.

### FIELD OF THE INVENTION

The present invention relates to the field of producing plastic containers by blow molding preforms. In particular, the invention relates to a component (or striker plate) of the blowing mold adapted to abut against the neck ring of the preform when the blowing mold is closed. The invention also relates to a container obtained by means of a blowing mold.

### BACKGROUND ART

Plastic containers, bottles, for example, conventionally are produced by blow molding a preform. The molds used in this process are called blow molds.

The preforms are typically provided with a neck ring which is used to support the preform. In blow molding processes, the neck of the preform is not modified during the molding. Blow molds are provided with a support adapted to abut against the neck ring of the preform so that the part from the neck ring to the opening of the neck remains outside the mold. A support designed to serve this function is also called a striker plate.
When the mold is closed, the molding surfaces extend around a same axis, also called axis of the mold.
The axis of the preform in particular is the axis around which the neck extends and which crosses the bottom of the preform.
Typically, the molding surfaces of a blowing mold are thermally conditioned (heated or cooled as a function of the process to be performed).
To obtain the blown container according to what is designed, specific areas of the mold must come into contact with specific areas of the preform.
In certain cases, the rotation of the preform around the axis thereof may be disadvantageous. Therefore, it is important for the preform not to rotate around the axis thereof, in particular when it is arranged in the mold.
Disadvantageously, the preform may actually rotate around the axis thereof when it is in the mold, for example when it is inserted into the mold and/or when the mold is closed.

It is also desirable for the axis of the preform to coincide with the axis of the mold when the preform is in the mold.

However, disadvantageously, the axis of the preform may actually not coincide with the axis of the mold, i.e. the preform may not be centered with the axis of the mold.
Therefore, the need is felt to overcome at least the problem relating to the rotation of the preform around the axis thereof, and possibly also the problem relating to the decentering of the preform, i.e., relative to the axis of the preform not coinciding with the axis of the mold.

FR2874193 describes a mold disadvantageously designed to function exclusively with a particular type of preform provided with a specific projection on the part of the preform above the neck ring. The mold in FR2874193 is provided with two driving elements (organes d'entraînement) which disadvantageously axially protrude above the abutment surface for the neck ring of the preform. The mold in FR2874193 is configured so that the two driving elements act in conjunction with the relief of the preform so that the preform rotates around the axis thereof when the mold is closed.

### SUMMARY OF THE INVENTION

It is an object of the present invention to provide a blowing mold which allows avoiding, or at least minimizing, the rotation of a preform around the axis thereof when it is in the blowing mold.

It is another object of the present invention to provide a blowing mold which also allows arranging and maintaining a preform so that the axis of the preform coincides with the axis of the mold, in particular with the axis of the closed mold.

It is an object of the present invention to provide a mold which in addition to achieving at least one of the aforesaid objects, is simple to construct and can be used with conventional preforms, in particular not provided with the aforesaid relief above the neck ring which, according to the prior art, is required in order to rotate the preform to orient it.

The present invention achieves at least one of such objects and other objects which will become apparent in light of the present description, by means of a blowing mold for molding a container, in particular a plastic bottle, by blow molding a preform having a neck and a neck ring,
the blowing mold being adapted to be opened and closed and comprising at least two parts which, when the blowing mold is closed, form a support, or striker plate, adapted to abut against the neck ring of the preform;
wherein a surface of said support is provided with one or more protrusions adapted to come into contact with the portion of the preform below the neck ring, in particular to prevent a rotation thereof.

In other words, at least one part of said at least two parts is provided with one or more protrusions adapted to come into contact with the neck of the preform, in particular to prevent a rotation thereof.

In particular, said one or more protrusions are adapted to come into contact with the portion of the preform below the neck ring of the preform to prevent a rotation of the preform when it is arranged in the mold, in particular to prevent a rotation of the preform around the axis around which the neck of the preform extends.

Said one or more protrusions advantageously are adapted to come into contact with the portion of the preform below the neck ring. In particular, said one or more protrusions are arranged to come into contact with the portion below the neck ring of the preform.

Each of said one or more protrusions is adapted to leave a corresponding impression on the container being molded. Each impression substantially is a recess or indentation.

Advantageously, the mold according to the invention does not require the preform to be positioned in the mold with a specific orientation. In particular, the preform may be arranged in the mold according to the invention with a random orientation.

Advantageously, the blowing mold according to the invention does not require the use of preforms provided with a specific relief above the neck ring for the orientation of the preform, as instead disadvantageously is required in the above-mentioned known mold.

Advantageously, the blowing mold according to the invention is easy and affordable to make. In particular, the blowing mold is simple to construct. More specifically, contrary to the above-mentioned known mold, the blowing mold according to the invention does not provide using driving elements which axially protrude above the support (or striker plate), which are intended to act in conjunction with the aforesaid relief of the preform described in the aforesaid document so that the preform rotates around the axis thereof when the mold is closed.

Therefore, advantageously a hollow tubular body may be used with a mold according to the invention, the hollow tubular body being adapted to abut against the upper surface of the neck ring and adapted to blow the preform, which tubular body is simpler to construct than a tubular body which instead must be used with a known mold mentioned above.

The invention also relates to a container, according to claim 16, on which there are one or more impressions, each impression being generated by a respective protrusion of said one or more protrusions.

Advantageously, also one protrusion alone is sufficient to avoid, or at least minimize, the rotation of the preform around the axis thereof, in particular when the preform is in the mold, in particular when the mold is closed.

In any case, said surface may be provided with more than one protrusion to better prevent the rotation of the preform around the axis thereof.

When more than one protrusion is provided, with a suitable arrangement of protrusions, a preform advantageously may be arranged and maintained so that the axis of the preform coincides with the axis of the mold, in particular with the axis of the closed mold. For example, at least two diametrically opposite protrusions may be provided when the blowing mold is closed; or three protrusions may be provided, arranged at about 120° from one another, when the mold is closed.

Further features and advantages of the invention will become more apparent in the light of the detailed description of exemplary, but non-exclusive embodiments thereof. The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a perspective view of an example of a blowing mold according to the invention, when it is closed;

FIG. 2 shows a detail of FIG. 1;

FIG. 3 shows a perspective view of the blowing mold in FIG. 1, when it is open;

FIG. 4 shows detail A in FIG. 3;

FIG. 5 shows a top view of the mold in FIG. 1, when it is closed;

FIG. 6 shows detail B in FIG. 5;

FIG. 7 shows a detail of FIG. 6;

FIG. 8 shows a perspective view of an example of a preform adapted to be blow molded by means of a blowing mold according to the invention;

FIG. 9 shows a perspective view of an example of a container, in particular a bottle, obtained by means of a blowing mold according to the invention.

The same elements or components have the same reference numerals.

### DESCRIPTION OF EMBODIMENTS OF THE INVENTION

With reference to the drawings, an example of a blowing mold 1 according to the invention is described.

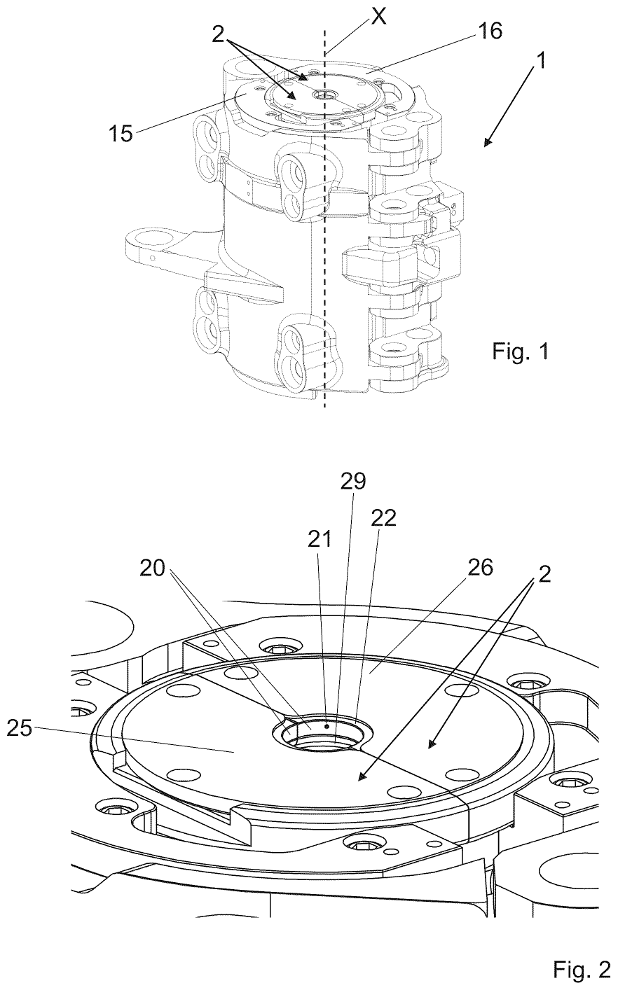

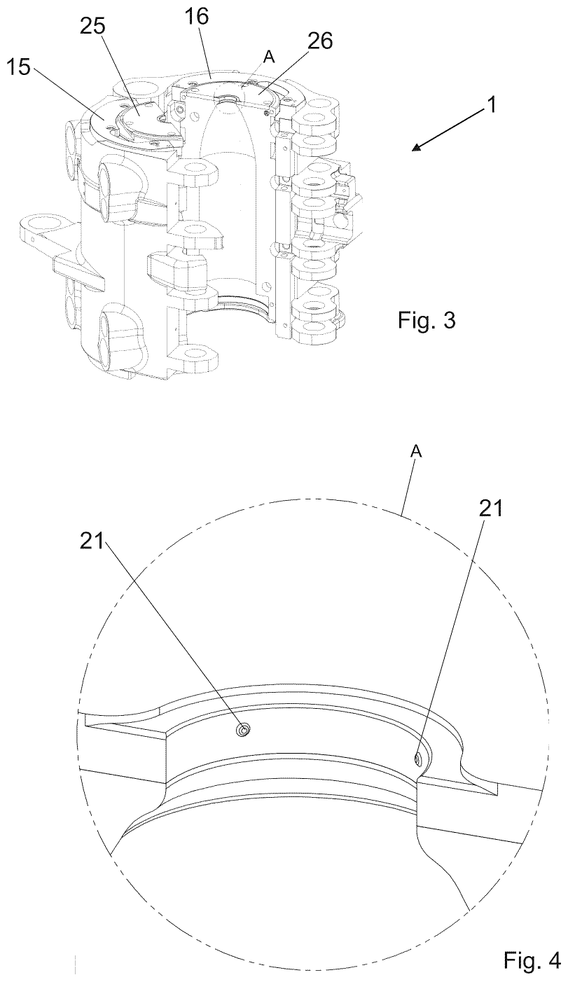

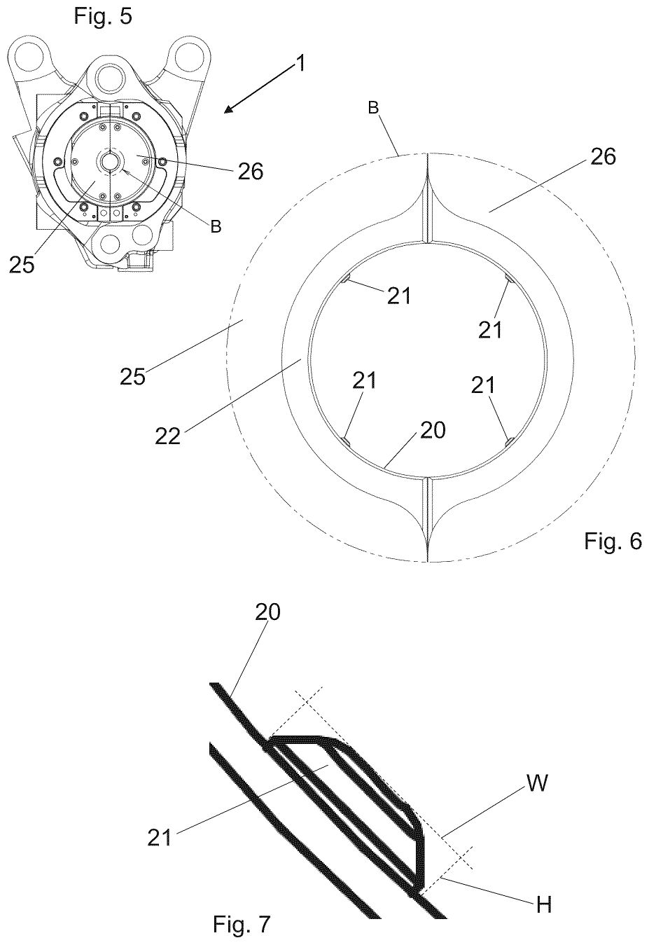

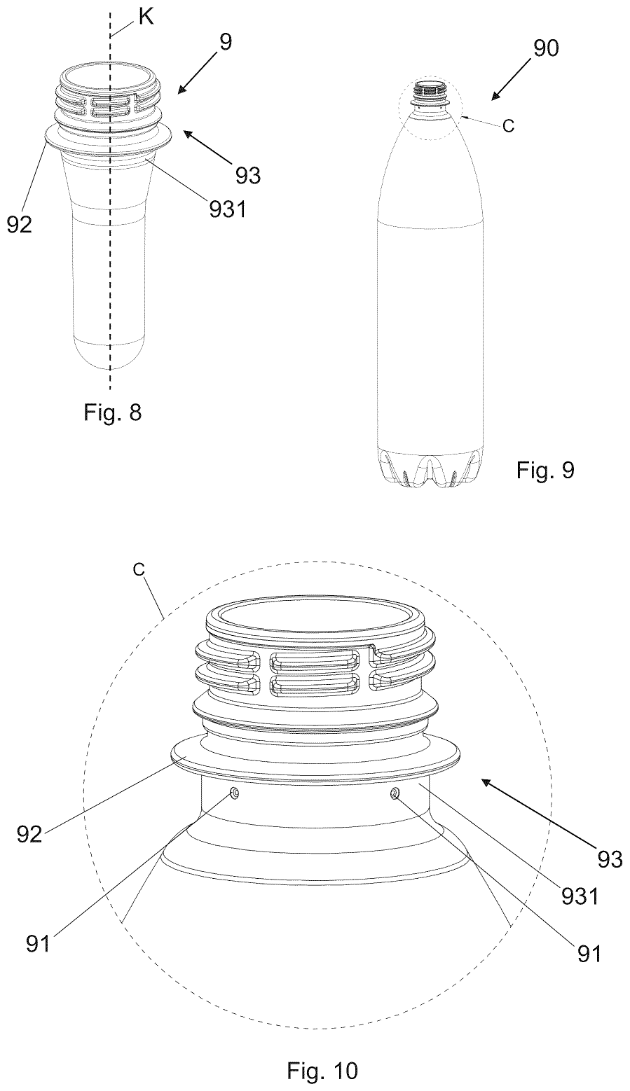

The blowing mold 1 serves to mold a container 90, in particular a plastic bottle (FIG. 9), by blow molding a preform 9 (FIG. 8) having a neck 93 and a neck ring 92 (or support ring). Preform 9, and therefore also container 90, are made of PET, for example. The neck ring 92 is adapted to be used to support preform 9.
The blowing mold 1, or mold 1, is adapted to be opened and closed. In particular, mold 1 may pass from a closed configuration (FIG. 1) to an open configuration (FIG. 3), and vice versa.
Mold 1 comprises at least two parts 25, 26 which form a support 2, or striker plate, when mold 1 is closed.
Preferably, in all the embodiments, the number of said at least two parts 25, 26 is equal to two (as in the example disclosed).
In particular, support 2 preferably is formed by two parts 25, 26 when mold 1 is closed. For example, each part 25, 26 substantially is a plate substantially having the shape of a circular half-crown. When the mold is closed, support 2 substantially is a plate substantially having the shape of a circular crown. The parts 25, 26 preferably are made of steel.
The two parts 25, 26 in particular are adapted to approach each other during the closure of mold 1 and to move away from each other during the opening of mold 1. In particular, mold 1 comprises two half-molds 15, 16 adapted to move away from and approach each other; more specifically, the two half-molds 15, 16 are hinged to each other so that mold 1 may be opened and closed. Each part 25, 26 of said two parts 25, 26 is fixed to a respective half-mold 15, 16. Preferably, each part 25, 26 is disassemblable from the respective half-mold 15, 16.

The aforesaid support 2 is adapted to abut against the neck ring 92 of preform 9, or in other words, the neck ring 92 of preform 9 is adapted to abut against said support 2. Support 2 in particular is a support for the neck ring 92 of preform 9. In particular, support 2 is adapted to come into contact with the lower surface of the neck ring 92 (the lower surface in particular is distal from the opening of the preform).

Advantageously, support 2 has a surface 20 provided with one or more protrusions 21 adapted to come into contact with the portion 931 of preform 9 below the neck ring 92, in particular to prevent a rotation thereof, in particular when preform 9 is arranged in mold 1. In particular, each part 25, 26 defines a respective portion of said surface 20.
In other words, at least one part 25, 26 of said at least two parts 25, 26 is provided with one or more protrusions adapted to come into contact with the portion 931 of preform 9 below the neck ring 92, in particular to prevent a rotation thereof.
The one or more protrusions 21 in particular are adapted to prevent a rotation of preform 9, which is arranged in mold 1, around axis K, or the central axis, of preform 9, around which neck 93 extends.
Advantageously, said one or more protrusions 21 are adapted to come into contact with the portion 931 of the preform below the neck ring 92. In particular, said one or more protrusions 21 are adapted to come into contact with said portion 931 when preform 9 is in mold 1, and in particular, when mold 1 is closed. “Below” in particular means towards the bottom of preform 9. Portion 931 in particular is immediately below the neck ring 92. In particular, portion 931 extends from the neck ring 92. Portion 931, for example, has a height along axis K of preform 9, starting from the neck ring 92, up to about 10 mm, for example up to about 5 mm. Portion 931 in particular is an annular portion, being substantially cylindrical in shape, for example. Portion 931 of preform 9, in particular the outer surface of portion 931, preferably is substantially smooth, in particular without projections.
Each protrusion 21 forms substantially a projection or protuberance with respect to surface 20 from which it extends. In other words, each protrusion 21 is a projection or protuberance.

Each protrusion 21 preferably is monolithic with the respective part 25, 26 adapted to form support 2.

Each protrusion 21 in particular is a radial protrusion, where the expression “radial” is used with reference to mold 1 closed. In particular, each protrusion 21 has a height H thereof (FIG. 7) with respect to surface 20 from which it extends. Height H of each protrusion 21 extends along an axis orthogonal to axis X of mold 1, in particular along a radial axis with respect to the axis X of mold 1 when it is closed. In particular, when mold 1 is closed, each protrusion 21 extends radially further inward with respect to surface 20 from which it extends. The dimensions of each protrusion 21 are in particular selected so as to penetrate the surface of preform 9, in particular without compromising the integrity thereof.
Preferably, height H is from 0.5 to 3 mm.
Each protrusion 21 has a width W (FIG. 7), measured substantially perpendicularly to height H. Width W preferably is from 0.5 to 3 mm.
Preferably, the extension of each protrusion 21 along axis X when mold 1 is closed is from 0.5 to 3 mm.
By mere way of non-limiting example, the shape of each protrusion 21 may be frustoconical, conical, cylindrical, semi-spherical, parallelepiped, or combinations thereof.
The one or more protrusions 21 in particular do not extend axially above (i.e., outward) support 2, i.e., they do not extend axially above the respective part 25, 26.

When mold 1 is closed, said surface 20 extends around axis X of the blowing mold. The axis X of mold 1 in particular is defined by mold 1 when it is closed. In particular, the molding surfaces of mold 1 extend around axis X when mold 1 is closed.

When mold 1 is closed, said surface 20 is substantially cylindrical, for example.

Support 2 in particular has a face 22, or annular portion (annular when mold 1 is closed) adapted to abut against the neck ring 92 of preform 9. In particular, each of the parts 25, 26 defines a respective portion of said face 22. The aforesaid surface 20 is transverse, preferably perpendicular, to said face 22 or annular portion. Said one or more protrusions 21 in particular are lower (i.e., more towards the bottom of mold 1) with respect to said face 22, in particular completely lower with respect to said face 22.

When mold 1 is closed, said surface 20 delimits an opening 29, in particular adapted to be crossed by preform 9. When mold 1 is closed, said surface 20 in particular is adapted to surround (in particular, it is adapted to come into contact with) the portion 931 of preform 9 which is below the neck ring 92.
Surface 20 in particular is defined by said two or more parts 25, 26 when mold 1 is closed. When mold 1 is open, each part 25, 26 defines a respective portion adapted to form surface 20.
Surface 20 in particular is an inner surface, more specifically, an inner side surface of support 2. More specifically, surface 20 is an inner surface, more specifically an inner side surface, of mold 1, in particular when it is closed. Surface 20 is a molding surface of mold 1.
The one or more protrusions 21 in particular are inside mold 1, in particular completely inside mold 1, in particular when mold 1 is closed. In other words, the one or more protrusions 21 extend into the molding cavity of mold 1, in particular the one or more protrusions 21 extend completely into the molding cavity of mold 1.
The number of protrusions 21 may be equal to one or greater than one.
When there is only one protrusion 21, only one of the two parts 25, 26 is provided with a protrusion 21, for example.
Preferably, two or more protrusions 21 are provided.
In addition to preventing the rotation of the preform around axis K thereof, the protrusions 21 may also allow centering preform 9 with respect to axis X of mold 1 if they are suitably arranged.
For example, for this purpose, two protrusions 21 which are diametrically opposite to each other may be provided, when mold 1 is closed; or two pairs of protrusions 21 may be provided, the protrusions of each pair being diametrically opposite to each other when mold 1 is closed (four protrusions arranged at about 90° from one another when mold 1 closed, for example); or three protrusions 21 may be provided, arranged at about 120° from one another, when mold 1 is closed.

Each of said one or more protrusions 21 is adapted to leave a corresponding impression 91, or indent, on container 90 being molded, in particular on the portion 931 below the neck ring 92. In particular, each protrusion 21 is adapted to penetrate the surface of preform 9 (which is the same surface of the container being blown), leaving a corresponding impression 91. Each impression 91 substantially is a recess, in particular a recess with respect to the rest of the surface of portion 931.

The invention also relates to a container 90, obtained by means of a blowing mold 1, having a neck 93. There are one or more impressions 91 on container 90, each impression 91 being produced by a respective protrusion 21 of said one or more protrusions 21. Each impression 91 in particular is on the portion 931 of container 90 below the neck ring 92.

1. A blowing mold for molding a plastic container, in particular a bottle, by blow molding a preform having a neck and a neck ring,
the blowing mold being adapted to be opened and closed, and comprising at least two parts which, when the blowing mold is closed, form a support, or striker plate, adapted to abut against the neck ring of the preform;
wherein a surface of said support is provided with one or more protrusions adapted to come into contact with the portion of the preform below the neck ring, in particular to prevent a rotation thereof.

2. The blowing mold according to claim 1, wherein each protrusion of said one or more protrusions has a height from 0.5 to 3 mm with respect to the surface from which it extends; said height in particular being along an axis orthogonal to the axis of the mold, the axis being the axis around which the molding surfaces of the mold extend when it is closed.

3. The blowing mold according to claim 2, wherein each protrusion of said one or more protrusions has a width from 0.5 to 3 mm, perpendicular to said height.

4. The blowing mold according to claim 1, wherein each of said one or more protrusions is adapted to leave a corresponding impression on the container being molded; in particular on the portion below the neck ring.

5. The blowing mold according to claim 1, wherein said surface is a molding surface of the mold.

6. The blowing mold according to claim 1, wherein when the mold is closed, said surface of the support is adapted to surround, in particular it is adapted to come into contact with, said portion of the preform below the neck ring.

7. The blowing mold according to claim 1, wherein when the mold is closed, said one or more protrusions are inside the mold, in particular completely inside the mold.

8. The blowing mold according to claim 1, comprising two or more protrusions.

9. The blowing mold according to claim 8, wherein two protrusions of said two or more protrusions are diametrically opposite to each other when the blowing mold is closed; or wherein three protrusions are provided, arranged at about 120° from one another, when the blowing mold is closed.

10. The blowing mold according to claim 1, wherein said support has a face adapted to abut against the neck ring of the preform; and wherein said surface is transverse, preferably perpendicular, to said face.

11. The blowing mold according to claim 1, wherein when the blowing mold is closed, said surface delimits an opening adapted to be crossed by the preform.

12. The blowing mold according to claim 1, wherein when the blowing mold is closed, said two parts define said surface of the support.

13. The blowing mold according to claim 1, wherein said two parts are adapted to approach each other during the closure of the blowing mold and to move away from each other during the opening of the blowing mold.

14. The blowing mold according to claim 1, comprising two half-molds;
wherein each part of said two parts is fixed to a respective half-mold.

15. The blowing mold according to claim 14, wherein each of said two parts is disassemblable from the respective half-mold.

16. A container obtained by means of a blowing mold according to claim 1, on which there are one or more impressions, each impression being produced by a respective protrusion of said one or more protrusions; in particular wherein each impression is on the portion below the neck ring.
